(19) United States
(12) Patent Application Publication
(10) Pub. No.: US 2017/0131064 A1
(43) Pub. Date: May 11, 2017

(54) BIOMECHANICAL ASSESSMENT SYSTEM FOR SHOOTING

(71) Applicant: Steven Dale Unruh, Oxford, MI (US)

(72) Inventor: Steven Dale Unruh, Oxford, MI (US)

(21) Appl. No.: 15/344,696

(22) Filed: Nov. 7, 2016

Related U.S. Application Data
(60) Provisional application No. 62/251,106, filed on Nov. 5, 2015.

(51) Int. Cl. F41C 27/00; G01P 1/07

(52) U.S. Cl. CPC F41C 27/00; G01P 1/07

(57) ABSTRACT

An assessment system including a data acquisition module. The data acquisition module includes an accelerometer, a gyroscope, a magnetometer, and a processor. The accelerometer, the gyroscope, and the magnetometer are adapted to generate data corresponding an initial location or position of the data acquisition module before a firearm is discharged. The accelerometer, the gyroscope, and the magnetometer are adapted to generate data corresponding movement, a location, or a position of the data acquisition module during and after the firearm is discharged. The processor is adapted to correlate the data from the accelerometer, the gyroscope, and the magnetometer to movement, a location, or a position of the firearm before, during, and after the firearm is discharged.

### FIELD

These teachings relate to an assessment system for firearms shooting.

### BACKGROUND

A number of factors can affect a shooter's ability to hit a target with a firearm. For example, external factors such as wind, precipitation, and visual obstacles can interfere with and affect a shooter's ability to hit a target with a firearm. Mechanical factors such as sight adjustment can also affect a shooter's ability to hit a target. Various control factors, such as the way a shooter breathes, his or her involuntary muscle movements, and/or the way the shooter handles the firearm and/or pulls the trigger, can also affect a shooter's ability to hit a target.

In an attempt to improve shooting performance, assessment tools have been proposed for evaluating how a user handles the firearm and/or pulls the trigger. As best understood, some of these assessment tools are adapted to track movement of the firearm before or during trigger pull. However, movement of the firearm after the trigger is pulled can also affect the ability to hit a target. Moreover, some assessment tools are adapted to only display a single data point on an X-Y coordinate system of the position of the firearm before or during trigger pull. However, adjusting a position or location of the firearm based on a single data point may not be precise, especially when a user wishes to adjust in only one direction, such as only in a horizontal or lateral direction. Some of these assessment tools are disclosed in U.S. Pat. No. 9,151,564; US Patent Application Publication Nos. 2013/0071815A1 and 2016/0033221A1; and in International Patent Publication No. WO 2016/115554, all of which are hereby incorporated by reference herein for all purposes.

Accordingly, it may be desirable to improve the current state of the art by providing an improved assessment system for firearms shooting. For example, it may be desirable to have an assessment system that is adapted to track and record movement of the firearm before, during, and after the trigger is pulled. Such information may be useful to a shooter to understand how they manage recoil of the firearm, and how recoil management affects their ability to handle the firearm and hit the target, for example. It may also be desirable to have an assessment system that is adapted to display individual X and Y data points corresponding to the position of the firearm before, during, and after the trigger is pulled so that a shooter can fine tune their handling of the firearm in a specific horizontal and/or vertical direction.

### SUMMARY

These teachings provide an improved assessment system for firearms. These teachings improve the current state of the art by providing an assessment system for shooting that is adapted to track and record movement of the firearm before, during, and after the trigger is pulled. Such information may be useful to a shooter to understand how they manage recoil of the firearm, and how recoil management affects their ability to handle the firearm and hit the target, for example. These teachings also provide an assessment system that is adapted to display individual X and Y data points corresponding to the position of the firearm before, during, and after a trigger pull so that a shooter can fine tune their handling of the firearm in a specific direction, for example, in a horizontal or lateral direction.

The assessment system according to these teachings includes a recorder. The recorder is adapted to be removably installed on a firearm. The recorder includes one or more sensors for detecting a position or location of the recorder and a processor for correlating the position or location of the recorder to a position or location of the firearm. The recorder includes one or more sensors for detecting a change in the position or location of the recorder, and a processor for correlating the change in the position or location of the recorder to a change in a position or location of the firearm before, during, and after the firearm is discharged. The recorder includes a processor for processing the data from the one or more sensors. The processed data is transmitted to a display or user interface for viewing or evaluation by the shooter. The display may be part of the assessment system, or the display can be an ancillary component, such as, for example, a tablet or smart phone. The user may review the data displayed on the display or user interface and determine how their handling of the firearm before, during, or after the firearm is discharged affects their ability to hit a target. From this data, the user may be able to modify or fine tune a variety of factors, such as, for example, the shooter's grip on the firearm, the shooter's breathing, the shooter's finger position on the trigger, the speed at which the shooter pulls the trigger, the shooter's stance and/or posture, or a combination thereof.

### BRIEF DESCRIPTION OF THE DRAWINGS

FIG. 1 is a perspective view of an exemplary firearm and the assessment system.

FIG. 2 is a block diagram of the assessment system.

### DETAILED DESCRIPTION

This disclosure claims the benefit of U.S. Provisional Patent Application No. 62/251,106 filed on Nov. 5, 2015 the disclosure of which is hereby incorporated by reference herein in its entirety for all purposes.

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

Assessment System.

The assessment system according to these teachings may function to monitor, measure, detect, determine, record and/or assess data reflecting a position or location of a data acquisition module prior to, during, and after the trigger is pulled and the firearm is discharged. The assessment system may monitor, measure, detect, determine, record and/or assess the exact movements of the data acquisition module before, during, and after the firearm is discharged. The movement, position and/or location of the data acquisition module is then correlated to movement, a position and/or location of the firearm prior to, during, and after the trigger is pulled and the firearm is discharged. This data is then displayed on a display for a shooter and/or coach to review.

Understanding the movement of the firearm and/or the location or position of the firearm before, during, or after the firearm is discharged can be advantageous to the shooter. For example, it is known that many factors can affect the shooter's ability to hit a target. Even the slightest movements before, during, or after the trigger is pulled can affect the shooter's ability to hit the target. These movements can be a function of a variety of factors, including the shooter's grip on the firearm, the shooter's breathing, the shooter's finger position on the trigger, the speed at which the shooter pulls the trigger, the shooter's stance and/or posture, or a combination thereof. These movements can be difficult to detect by the shooter while shooting or even a coach who is observing a shooter. Thus, advantageously, a user may review the data provided by the assessment system, and use the data to their advantage to adjust a variety of factors to improve their ability to hit a target. Based on the acquired data, the assessment system may also provide the user with suggestions to improve their ability to hit a target. From this data, the user may decide to, for example, modify, adjust, or fine tune the shooter's grip on the firearm, the shooter's breathing, the shooter's finger position on the trigger, the speed at which the shooter pulls the trigger, the shooter's stance and/or posture, or a combination thereof.

Firearm.

The assessment system may be used with a firearm. The firearm may be any firearm that is adapted to shoot or fire a projectile. For example, the firearm may be a pistol, a hand gun, a rifle, or a shot gun. The firearm may be an automatic firearm, a semi-automatic firearm, or a pump firearm. The firearm may be an airsoft or CO2-powered firearm. The firearm can be a bow-and-arrow. The firearm can be a cross-bow.

Data Acquisition Module.

The assessment system may include a data acquisition module. The data acquisition module may function to monitor, measure, detect, determine, record and/or assess movement, a position and/or a location of the module and thus the firearm before, during, and after the trigger is pulled. The data acquisition module may include a circuit board, one or more sensors, a processor, memory, a power source, a communication device, or a combination thereof. The data acquisition module may comprise a housing containing these aforementioned components.

The data acquisition module may be attached to any portion of the firearm. For example, the data acquisition module may be attached to the barrel of the firearm. The data acquisition module can be mounted to an accessory rail of the firearm. For example, the data acquisition module can be attached to the firearm by sliding the assessment system onto the barrel or rail of the firearm, and then secured thereto with a fastener, such as a set screw, for example. It is also envisioned that the data acquisition module can be mounted to the trigger guard, magazine, the barrel, and/or the stock.

Magnetometer.

The data acquisition module may include one or more magnetometers. The magnetometer may function to detect an orientation of the data acquisition module, and thus an orientation of the firearm, the trigger, and/or the barrel relative to a known location before, during, and after the firearm is discharged. For example, the magnetometer may act as a compass and determine an absolute orientation of the data acquisition module and the firearm in a north-south-east-west coordinate system. The magnetometer may function to assist in calibrating the data acquisition module and determining an initial position or location of the data acquisition module relative to the ground, for example. The magnetometer may protect against orientation drift. The magnetometer may be a 3-axis magnetometer.

Accelerometer.

The data acquisition module may include one or more accelerometers. The accelerometer may function to measure acceleration of the data acquisition module, and thus the firearm before, during, and after the firearm is discharged. The accelerometer may function to measure changes in velocity and/or position of the data acquisition module, the firearm, or both. The accelerometer may function to determine when the firearm has been discharged. The accelerometer may be used to determine movements of the data acquisition module, and thus the firearm. For example, the accelerometer may be adapted to understand when the firearm has been discharged by requiring a threshold velocity and/or position to be detected before the velocity and/or position of the recorder is measurements are recorded with the accelerometer. This threshold may be selected so as to be greater than the forces expected from normal handling of the firearm, such as disengaging the safety.

Gyrscope.

The data acquisition module may include one or more gyroscopes. The gyroscope may function to measure and determine changes in orientation of the data acquisition module and thus the firearm before, during, and after the firearm is discharged. The gyroscope may function to determine changes in the rotational velocity of the data acquisition module and thus the firearm. The gyroscope may function to determine angular rates of rotation about the pitch (x), roll (y), and yaw (z) axes of the data acquisition module and thus the firearm. The gyroscope may be a 3-axis gyroscope.

Processor.

The data acquisition module may include a processor. The processor may function to receive, read, process, assess, interpret and/or compute data acquired by one or more of the magnetometer, accelerometer, and/or gyroscope. The processor may correlate the data from the magnetometer, accelerometer, and/or gyroscope to a position, location, and or movement of the firearm before, during, and after the firearm is discharged. The processor may compute an exact X position and an exact Y position of the firearm before, during, and after the firearm is discharged. Therefore, for each discharge of the firearm, the processor may understand six data points (i.e., X and Y position of firearm before, during, and after discharge). The processor may include one or more algorithms, mathematical equations, and/or a look-up table for correlating the data to movement of the firearm. The processor may be a computer, a processor, a microprocessor, or a combination thereof. The processor may include memory for storing the data from the magnetometer, accelerometer, and/or gyroscope. The processor may be located in the data acquisition module, or the processor may be part of the display.

Memory.

The data acquisition module may include memory. The memory may be used to store collected data from the magnetometer, accelerometer, and/or gyroscope. The memory may be used to store data to establish movement, location, and/or position trends.

Communication Device.

The data acquisition module may include a communication device. The communication device may function to transmit or send data collected and/or processed by the data acquisition module or processor to a display. The communication device may be a wired or wireless device. For example, the communication device may be a USB connection. For example, the communication device may be a communication protocol such as Bluetooth, WIFI, 802.11, CDMA, GSM or other cellular or wireless communication.

Display.

The data from the data acquisition module may be transmitted or communicational by the data acquisition module to a display. The display may be part of the system, or the display can be an ancillary component supplied by the user such as a computer, tablet, screen, smartphone, or cellular phone. The display may be an app running on a tablet or computer that is adapted to interpret and compute the data from the data acquisition module and display the results on the display. The display may display the position, location, and/or movement of the firearm before, during, and/or after the firearm is discharged. The display may display the exact X position and the exact Y position of the firearm collected by the magnetometer, gyroscope and/or accelerometer before, during, and after the firearm is discharged each time. Therefore, for each time the firearm is discharged, the data displayed on the display includes the exact X position and the exact Y position of the firearm before, during, and after the firearm is discharged so that at least six data points are displayed on the display.

Power Source.

The data acquisition module may include a power source. The power source may function to power the data acquisition module, the processor, the memory, the communication device, the magnetometer, the gyroscope, the accelerometer, or any other component of the data acquisition module. The power source may be a rechargeable DC power source. For example, the power source may be a lithium rechargeable battery.

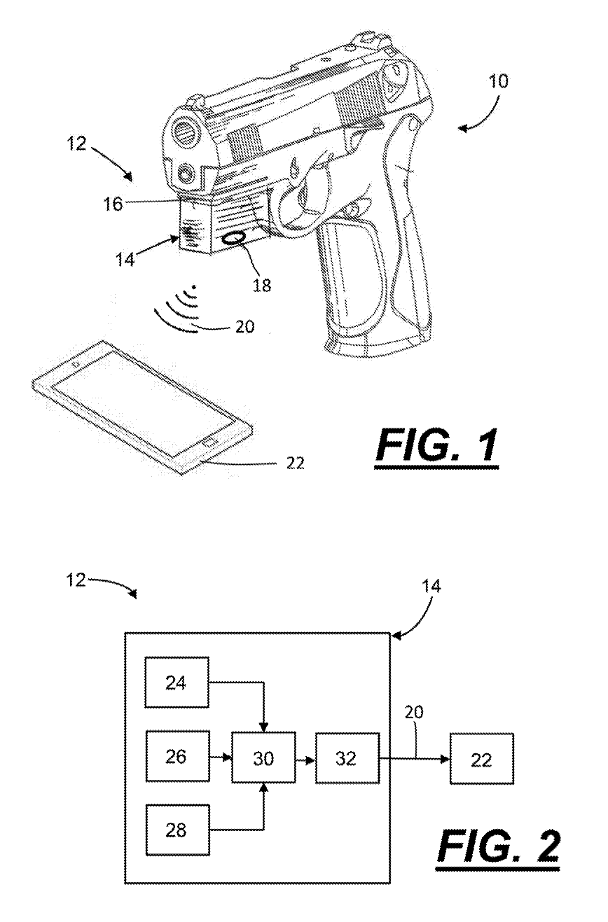

FIG. 1 illustrates an exemplary firearm 10 and assessment system 12. The assessment system 12 comprises a data acquisition module 14. The data acquisition module 14 is attached to the rail 16 of the firearm 10. The data acquisition module 14 comprises a button 18 for calibrating the data acquisition module 14 and for establishing an initial position or location of the data acquisition module 14 relative to the ground. As will be discussed with reference to FIG. 2, data collected by data acquisition module 14 is transmitted via a signal 20 to a display 22.

FIG. 2 illustrates a block diagram of the assessment system 12. The data acquisition module 14 comprises a magnetometer 24, an accelerometer 26, and a gyroscope 28. Data from the magnetometer 24, an accelerometer 26, and a gyroscope 28 is transmitted to a processor 30 for determining movement, a position and/or location of the firearm 10 before, during, and after the trigger of the firearm 10 is pulled and the firearm 10 discharged. Data from the processor 30 is provided to a communication device 32 for transmitting the data via the signal 20 to the display 22.

Referring to both FIGS. 1 and 2, the data acquisition module 14 can be attached to the firearm 10. A position or location of the data acquisition module 14 can be determined by calibrating the data acquisition module 14. This may be accomplished by pressing button 18. The location of the data acquisition module 14 can be stored in the memory. After a position or location of the data acquisition module 14 is determined and recorded, as the shooter aims the firearm 10, movements and/or changes in the position or location of the data acquisition module 14 is determined with the magnetometer 24, an accelerometer 26, and a gyroscope 28. These movements, the position or location changes are recorded in the memory. Movements and/or the position or location of the data acquisition module 14 is also measured and recorded during and after the firearm 10 is discharged. This data is also stored in the memory. All of the data is then communicated to the processor 30 for correlating the initial position of the data acquisition module 14 and the movements and changes in the location or position of the data acquisition module 14 before, during, and after the trigger is pulled to the movements, the position or location of the firearm 10 before, during, or after the trigger is pulled. The determined positions of the firearm 10 before, during, and after the discharge can be communicated to the display 22 with the communication device 32.

The shooter may then review the data displayed on the display 22 and understand how movements of the firearm 10 before, during, or after the firearm 10 is discharged affects their ability to hit a target. The shooter may then choose to modify, adjust, or fine tune their grip on the firearm, their breathing, finger position on the trigger, the speed at which the trigger is pulled, their stance and/or posture, or a combination thereof to improve their ability to hit the target. The shooter can continue to use the assessment system 10 to determine how changes in their grip on the firearm, their breathing, finger position on the trigger, the speed at which the trigger is pulled, their stance and/or posture, or a combination affects their ability to hit the target.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1) An assessment system comprising:
a data acquisition module comprising an accelerometer, a gyroscope, a magnetometer, and a processor,
wherein the accelerometer, the gyroscope, and the magnetometer are adapted to generate data corresponding an initial location or position of the data acquisition module before a firearm is discharged,
wherein the accelerometer, the gyroscope, and the magnetometer are adapted to generate data corresponding movement, a location, or a position of the data acquisition module during and after the firearm is discharged,
wherein the processor is adapted to correlate the data from the accelerometer, the gyroscope, and the magnetometer to movement, a location, or a position of the firearm before, during, and after the firearm is discharged.

2) The assessment system according to claim 1, wherein the data acquisition module is attached to a rail of the firearm.

3) The assessment system according to claim 1, wherein the movement, the location, or the position of the firearm before, during, and after the firearm is discharged is communicated from the data acquisition module to a display for viewing by a shooter.

4) The assessment system according to claim 3, wherein the data is communicated from the data acquisition module to the display wirelessly.

5) The assessment system according to claim 3, wherein the display shows the shooter the individual X position and the individual Y position of the firearm before, during, and after the firearm is discharged each time.

6) The assessment system according to claim 5, wherein the data acquisition module collects data each time the firearm is discharged, the data collected includes the exact X position and the exact Y position of the firearm before, during, and after the firearm is discharged, and
wherein a total of six data points are displayed on the display for each discharge of the firearm.

7) The assessment system according to claim 1, wherein the firearm is a hand gun.

8) A method of accessing a shooter's ability to hit a target, the method comprising:
attaching a data acquisition module to a firearm;
calibrating the data acquisition module to establish a position and location of the data acquisition module,
collecting data with the data acquisition module of the position and the location of the data acquisition module before the firearm is discharged,
discharging the firearm,
collecting data with the data acquisition module of the position and the location of the data acquisition module during and after the firearm is discharged,
processing the data with a processor of the acquisition module; and
communicating the data to a display;
wherein six data points are displayed on the display for each discharge of the firearm, the data points correspond to an exact X location and Y location of the firearm before, during, and after discharge of the firearm.

9) The method according to claim 8, wherein the data acquisition module comprises a gyroscope, accelerometer, magnetometer, the processor, and a communication device for communicating the data to the display.

10) The method according to claim 9, wherein the attaching step includes attaching the data acquisition module to a rail of a firearm.

11) An assessment system comprising:
a data acquisition module connected to a firearm,
wherein the data acquisition module is adapted to generate data corresponding an initial location or position of the data acquisition module before a firearm is discharged,
wherein the data acquisition module is adapted to generate data corresponding movement, a location, or a position of the data acquisition module during and after the firearm is discharged,
wherein a processor in the data acquisition module is adapted to correlate the data from the data acquisition module to movement, a location, or a position of the firearm before, during, and after the firearm is discharged, and
wherein the data acquisition module communicates the movement, the location, and/or the position of the firearm before, during, and after the firearm is discharged to a display, and
wherein six data points are displayed on the display for each discharge of the firearm, the data points correspond to an exact X location and Y location of the firearm before, during, and after discharge of the firearm.

12) The assessment system according to claim 11, wherein the data acquisition module comprises one or more gyroscopes, one or more accelerometer, and one or more magnetometers.

13) The assessment system according to claim 12, wherein the movement, the location, and/or the position of the firearm before, during, and after the firearm is discharged is communicated via Bluetooth to the display.

14) The assessment system according to claim 12, wherein the data acquisition module is connected to a rail of the firearm, and
wherein the firearm is a hand gun or a rifle.

15) The assessment system according to claim 12, wherein the data acquisition module comprises a rechargeable battery.
